(19) United States
(12) Patent Application Publication
(10) Pub. No.: US 2008/0111331 A1
(43) Pub. Date: May 15, 2008

(54) Infant stroller with integrated entertainment system

(76) Inventor: Mark A. Koehl, Beverly Hills, FL (US)

Correspondence Address: Galasso & Associates, LP, P.O. Box 26503, Austin, TX, 78755-0503, US

(21) Appl. No.: 11/599,046

(22) Filed: Nov. 14, 2006

(51) Int. Cl. B62B 7/04

(52) U.S. Cl. 280/47.38

(57) ABSTRACT

A child transportation system designed to receive and subsequently facilitate transportation of a child and further being configured to produce a plurality of audio and visual stimuli for the child disposed therein. The child transportation system includes a frame superposed on a plurality of wheels having a compartment for receiving a child secured to the frame. Integrally secured to a wall of the compartment is an entertainment unit. The entertainment unit is configured to produce a plurality of audio and visual stimuli utilizing media formats such as but not limited to CDs and DVDs.

### FIELD OF THE INVENTION

The present invention relates to an infant transportation device with an integral entertainment system, more specifically but not by way of limitation an infant stroller having compartment for receiving a child therein with an integrated multimedia device that is capable of providing audio and visual stimulation to an infant disposed within the stroller.

### BACKGROUND

Caring for infants can be a very demanding task. During long trips or even while engaged in short errands, infants often can become fretful or annoyed. Typically during the daily childcare routine, a caretaker will utilize many different devices to assist in either the transportation of the child or to create a safer environment for the child. Devices such as baby strollers and playpens are routinely utilized by caretakers during the normal daily routine of caring for a child.

During the infant stage, caretakers facilitate behavioral management and development of the child by providing many methods of stimulation for the infant. As is known to those skilled in the art, one issue that caretakers endure during caring for a child is that infants and small children usually do not like to be confined to a small area such as a stroller or playpen for any significant amount of time. Being constrained to these small areas can create an isolating experience for the child thus causing the child to become fretful or annoyed. Having the ability to provide long term audio and visual stimulation not only leads to the behavioral development of the child but eases the stress level of the child's caretaker.

Additionally, children that are protected by caretakers utilizing playpens to create a safer environment for the child also need stimulation in there immediate surroundings. While there are many devices that provide stimulation for a child while the child is being transported in a stroller or contained within a playpen, there are no current devices having an electronic multimedia device that is an integral part of the stroller or playpen that is capable of producing a variety of stimulus such as but not limited to an educational movie utilizing such media formats such as but not limited to CDs and DVDs.

Accordingly there is a need for a device that is capable of providing stimulus such as audio and video signals for a child that is either being transported in a stroller or contained within a playpen that is an integral part thereof having the capability of providing methods of stimulation such as but not limited to the ability to play media contained on a disc.

### SUMMARY OF THE INVENTION

It is the object of the present invention to provide a child stroller having a compartment configured to receive a child therein with the compartment having integrally contained therein an entertainment system that is designed to provide audio and visual stimulation to the child disposed within the device.

A further object of the present invention is to provide a child stroller with an integrated entertainment system wherein the entertainment system further includes a method of playing media contained on a disc.

Yet another object of the present invention is to provide a child stroller with an integral entertainment system that is battery operated.

Another object of the present invention is to provide a child stroller with an integral entertainment system where the entertainment system is water resistant.

An additional object of the present invention is to provide a child stroller with an integral entertainment system that is lightweight and inexpensive.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of a child transportation device that has an entertainment system integrally built into the wall of the compartment of the child transportation device; and

FIG. 2 is a perspective view of an embodiment of an entertainment system removed from the child transportation device.

### DETAILED DESCRIPTION

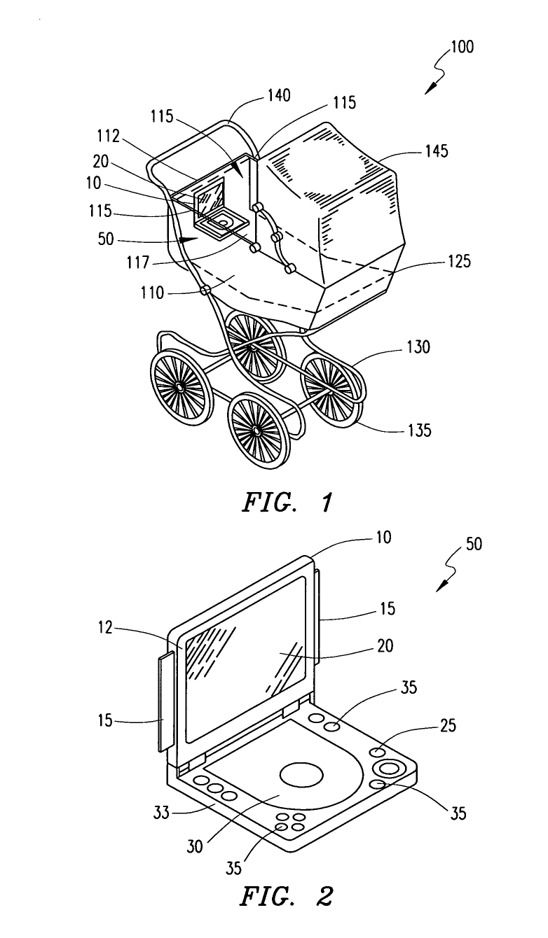

Referring now to the drawings, wherein various elements depicted therein are not necessarily drawn to scale and wherein like elements are designated with like reference numerals throughout the views and figures, and in particular to FIG. 1, there is illustrated a child transportation device 100 constructed according to the principles of the present invention.

The child transportation device 100 comprises a frame 130 superposed on a plurality of wheels 135 having a compartment 110 secured to the frame 130 by suitable mechanical methods with the compartment 110 being configured to receive a child therein. The compartment 110 includes a front wall 112, two side walls 115, a bottom 117 and a rear wall 125 configured to define an interior volume. A hood 145 is superposed on a portion of the compartment 110 proximate to the rear wall 125. Extending from the frame 130 proximate the front wall 112 is a handle. As is known in the art, the child transportation device 100 functions to assist a caretaker transport a child to a desired location.

Those skilled in the art should recognize that numerous configurations of the child transportation device 100 could exist and still retain the functionality as described herein. It is contemplated within the scope of the present invention that numerous configurations of the compartment 110, frame 130 and wheels 130 are possible. More specifically but not by way of limitation, the compartment 110 could be constructed from as few as one wall and a bottom 117 defining an interior volume configured for the receipt of a child therein. Additionally, the amount of wheels 135 utilized to maneuver the child transportation device 100 over suitable terrain could vary depending on the style of frame 130 construction thereby utilizing a greater or lesser number of wheels 135 that are illustrated in the drawings submitted herewith.

Integrally mounted to the front wall 112 of the compartment 110 is an entertainment unit 50. The entertainment unit 50 is configured to produce a variety of visual and audio stimuli. As shown in particular in FIG. 2, the entertainment unit 50 includes a housing 10 that is manufactured from a durable suitable material such as but not limited to plastic. Disposed within the upper portion 12 of the housing 10 is a video display screen 20 such as but not limited to a liquid crystal display screen. Contiguously formed with the housing 10 on opposing sides of the video display screen 20 are mounting flanges 15. The mounting flanges 15 are secured to the housing 10 by suitable chemical or mechanical methods and are generally rectangular in shape. Those skilled in the art will recognize that the mounting flanges 15 could be constructed in numerous different shapes and still achieve the functionality as described herein. The mounting flanges 15 facilitate the integral securing of the entertainment unit 50 to the front wall 112 of the compartment 110. The entertainment unit 50 is integrally mounted to the front wall 112 compartment 110 utilizing the mounting flanges 15 by suitable mechanical methods. Integrally securing the entertainment unit 50 with the front wall 112 facilitates the viewing of the video display screen 20 by a child that is disposed within the compartment 110.

Although the embodiment illustrated in FIG. 1 illustrates the entertainment unit 50 integrally mounted to the front wall 112, it is further contemplated within the scope of the present invention that the entertainment unit 50 could be integrally mounted to other areas of the compartment 110 and be visible to a child disposed within the compartment 110. More specifically but not by way of limitation, the entertainment unit 50 could be integrally mounted to the side walls 115 or the inwardly facing surface of the hood 145. It is also contemplated within the scope of the present invention that the child transportation device 100 could be configured with more than one video display screen 20 to accommodate viewing from a plurality of positions of the child disposed within the compartment 110. While no particular size of the entertainment unit 50 is required, good results have been achieved with an entertainment unit that is approximately eighteen and a half centimeters in height, eighteen and a half centimeters in width and five and one half centimeters in thickness.

The lower portion 33 of the entertainment unit 50 is hingedly attached to the upper portion 12. Although the embodiment of the present invention illustrated in FIG. 2 shows the entertainment unit 50 as having an upper portion 12 and a lower portion 33 hingedly secured thereto, it is contemplated within the scope of the present invention that numerous configurations of the entertainment unit 50 are possible. More specifically but not by way of limitation, the entertainment unit 50 could be manufactured as a one piece unit. Additionally, the entertainment unit 50 could consist of a portion containing the video display screen 20 and having operably connected thereto via electrical wires or a wireless connection a controller unit functioning to operate the video display screen 20.

The lower portion 33 has mounted thereon a plurality of control buttons 35 that function to control the entertainment unit 50. The functionality of the control buttons 35 includes but is not limited to activating the entertainment unit 50 and controlling conventional audio and visual display features as is known in the art. Disposed within the lower portion 33 of the entertainment unit 50 are the necessary electronics, power supply and circuits that are required to operate the entertainment unit 50 and additionally receive, store, manipulate and produce a variety of audio and visual stimuli. It is contemplated within the scope of the present invention that the entertainment unit 50 is powered by suitable methods such as but not limited to rechargeable batteries.

The lower portion 33 has mounted thereon a disc loading surface 30 whereby a user can releasably secure a digital video disc to the entertainment unit 50 for subsequent use thereof. Although the entertainment unit 50 is illustrated in the drawings submitted herewith as being configured to receive a CD or DVD, it is further contemplated within the scope of the present invention that numerous different types of media could be utilized to store and subsequently play audio and visual stimulation with the entertainment unit 50. More specifically but not by way of limitation, the entertainment unit 50 could store and utilize audio or visual data files with an integral hard disk drive. Additionally, the entertainment unit 50 could be configured with the necessary electronics to receive wireless signals from network providers in order for the entertainment unit 50 to connect to the internet and/or television signals to provide additional methods of audio and/or visual stimulation.

It is further contemplated within the scope of the present invention that the entertainment unit 50 is manufactured by suitable methods such that the entertainment unit 50 is water resistant. Although not illustrated in the drawings submitted herewith, it is also contemplated that the entertainment unit 50 could be integrally mounted and manufactured with a conventional child playpen having four walls and a bottom configured to define an area for a caretaker to secure a child during play or rest. The entertainment unit 50 would have similar functionality as described herein and be integrally mounted to at least one of the walls of the child's playpen.

Referring to the Figures, a description of the operation of the child transportation device 100 is as follows. In use, a caretaker will place the child in the child transportation device 100 whereby the child is facing the front wall 112 that has the entertainment unit 50 integrally mounted thereon. The caretaker releasably secures a CD or DVD to the disc loading surface 30. Utilizing the control buttons 35, the caretaker then initiates the playing of the media contained on the CD or DVD for the child. The caretaker can subsequently maneuver the child transportation device 100 as required with the child being provided with audio and/or visual stimulation by the entertainment unit 50.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An infant containment device comprising:
a compartment, said compartment being configured to have an interior volume sufficient for receiving an infant therein; and
an entertainment system integrated with said compartment, said entertainment system operable to generate at least one of visual stimulation and audio stimulation.

2. The infant containment device as recited in claim 1, wherein said compartment further includes at least one wall with said entertainment system being integrally secured to said at least one wall with at least one mounting flange.

3. The infant containment device as recited in claim 2, wherein said entertainment system further includes a display screen operable to generate visual stimulation.

4. The infant containment device as recited in claim 3, wherein said entertainment system includes an interface for receiving data such that said entertainment system generates said at least one of visual stimulation and audio stimulation corresponding to said received data.

5. The infant containment device as recited in claim 4, wherein said entertainment system being secured to said at least one wall with a plurality of mounting flanges.

6. The infant containment device as recited in claim 4, and further including a plurality of wheels connected to said compartment for facilitating mobility.

7. The infant containment device as recited in claim 6, wherein said entertainment system is further configured to receive a disc containing data such that said entertainment system generates said at least one of visual stimulation and audio stimulation corresponding to said data on said disc.

8. A carrier operable to transport a child comprising:
a compartment, said compartment having at least one wall and a bottom configured to define an interior volume, said volume being sufficient for receiving a child therein; and
an entertainment unit integrally mounted to said at least one wall of said compartment, said entertainment unit operable to generate at least one of visual stimulation and audio stimulation.

9. The carrier as recited in claim 8, wherein said entertainment unit is integrally mounted to said at least one wall of said compartment with at least one mounting flange.

10. The carrier as recited in claim 9, wherein said entertainment unit further includes a display screen operable to generate said visual stimulation.

11. The carrier as recited in claim 10, wherein said entertainment unit includes an interface for receiving data such that said entertainment unit generates said at least one of visual stimulation and audio stimulation corresponding to said received data.

12. The carrier as recited in claim 11, wherein said entertainment unit being integrally mounted to said at least one wall of said compartment with a plurality of mounting flanges, and further including a plurality of wheels connected to said compartment for facilitating mobility.

13. The carrier as recited in claim 12, wherein said entertainment unit is further configured to receive a disc containing data such that said entertainment unit generates said at least one of visual stimulation and audio stimulation corresponding to said data on said disc.

14. A child transportation system configured for transporting a child comprising:
a compartment, said compartment having four walls and a bottom configured to define an interior volume being of sufficient size to accommodate a child therein; and
an entertainment unit, said entertainment unit being integrally secured to one of the four walls, said entertainment unit further being configured to receive, store, manipulate and utilize data in order to generate at least one of visual stimulation and audio stimulation.

15. The child transportation system as recited in claim 14, wherein said entertainment unit is secured to one of the four walls utilizing at least one mounting flange peripherally secured to said entertainment unit.

16. The child transportation system as recited in claim 15, wherein said entertainment unit includes a display screen operable to generate visual stimulation.

17. The child transportation system as recited in claim 16, wherein said entertainment unit includes an interface for receiving data such that said entertainment unit generates said at least one of visual stimulation and audio stimulation corresponding to said received data.

18. The child transportation system as recited in claim 17, wherein said entertainment unit being secured to one of the four walls utilizing a plurality of mounting flanges peripherally secured to said entertainment unit.

19. The child transportation system as recited in claim 18, wherein said entertainment unit is further configured to receive a disc containing data such that said entertainment unit generates said at least one of visual stimulation and audio stimulation corresponding to said data on said disc.

20. The child transportation system as recited in claim 19, wherein said entertainment unit is battery powered.
